(19) United States
(12) Patent Application Publication
(10) Pub. No.: US 2014/0125942 A1
(43) Pub. Date: May 8, 2014

(54) Temple Folding Structure on a Pair of Eyeglasses

(71) Applicant: Wen-Tse Huang, Kaohsiung City (TW)

(72) Inventor: Wen-Tse Huang, Kaohsiung City (TW)

(21) Appl. No.: 13/669,523

(22) Filed: Nov. 6, 2012

(51) Int. Cl. G02C 5/14

(52) U.S. Cl. 351/121

(57) ABSTRACT

A temple folding structure on a pair of eyeglasses includes a lens frame and a temple. The lens frame and the temple respectively include an engaging portion and spaced upper and lower connection segments. The engaging portion includes a mounting hole with a plurality of teeth formed on an inner surface of the mounting hole. A pivot is provided on each of a bottom surface of the upper connection segment and a top surface of the lower connection segment and includes a plurality of anchoring teeth. The upper and lower connection segments clamp the engaging portion, with the pivots inserted into the mounting hole and with the anchoring teeth meshing with the teeth in the mounting hole, allowing the temple to be pivoted and positioned at various angles relative to the lens frame.

### BACKGROUND OF THE INVENTION

1. Field of the Invention

The present invention relates to a temple folding structure on a pair of eyeglasses and, more particularly, to a foldable joint structure linking a lens frame and a temple.

2. Description of the Related Art

Existing lens frames and temples are connected by screws to form pivotable structures. As shown in FIG. 1, a conventional temple folding structure of a pair of eyeglasses includes a lens frame 10 and a temple 12. A hinge part 11 is provided on each side of the lens frame 10 and includes two spaced hinge lugs 111. A hinge link 121 is formed on an inner end of the temple 12 and held between and coupled with the hinge lugs 111 by penetration of a screw 13. Accordingly, the temple 12 based on the screw 13 as one shaft completes fold outward or inward relative to the lens frame 10.

However, it is inconvenient for one user to tighten the screw 13 from time to time because the screw 13 which may be turned with the temple 12 during outward or inward fold is unscrewed and loses its attachment strength after a period of time. Furthermore, the temple 12 may be difficultly folded in case of a screw's strong attachment strength. On the other hand, the temple 12 may be easily shaken to collide with the lens frame or lenses in case of a screw's weak attachment strength. This issue possibly influences a consumer's inclination to purchase any high-price eyeglasses and deserves to be improved.

### BRIEF SUMMARY OF THE INVENTION

In order to overcome the deficiencies of the prior art, a primary objective of the present invention is to provide a temple folding structure on a pair of eyeglasses that needs no screw for assembly and can keep temples at various angles freely.

To achieve the foregoing objective, a temple folding structure on a pair of eyeglasses of the present invention includes a lens frame and a temple. The lens frame includes an engaging portion formed at one of two lateral sides of the lens frame. The engaging portion includes upper and lower faces spaced in an axial direction and a mounting hole extending from the upper face through the lower face in the axial direction. A plurality of teeth is formed on an inner surface of the mounting hole and extends in the axial direction. The temple includes an inner end pivotably connected to the lateral side of the lens frame and includes upper and lower connection segments formed at the inner end of the temple and spaced in the axial direction. A pivot is provided on each of a bottom surface of the upper connection segment and a top surface of the lower connection segment and includes a plurality of anchoring teeth distributed around the pivot and extending in the axial direction. The upper and lower connection segments clamp the engaging portion, with the pivots on the upper and lower connection segments respectively inserted into upper and lower sections of the mounting hole and with the anchoring teeth meshing with the teeth in the mounting hole, allowing the temple to be pivoted relative to the lens frame about an axis defined by the pivots.

In a preferred form, the mounting hole of the lens frame is formed by a combination of a through-hole and a coupling cylinder compactly held in the through-hole. The through-hole extends from the upper face through the lower face of the engaging portion. The coupling cylinder includes a plurality of teeth formed on an inner surface of the coupling cylinder and extending in the axial direction. The pivot is formed by a combination of a protruding portion and a toothed ring securely engaged around the protruding portion. The protruding portion is provided on each of the bottom surface of the upper connection segment and the top surface of the lower connection segment. The toothed ring has the plurality of anchoring teeth extending in the axial direction and matching the teeth.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows an exploded, perspective view of a conventional temple folding structure.

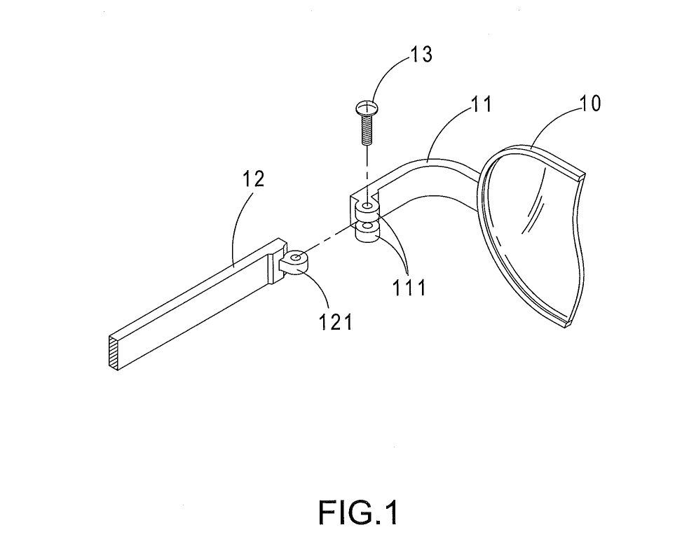

FIG. 2 shows a perspective view of a temple folding structure on a pair of eyeglasses according to a first embodiment of the present invention.

FIG. 3 shows an exploded, perspective view of the temple folding structure of FIG. 2.

FIG. 4 shows an exploded, perspective view of a temple folding structure according to a second embodiment of the present invention.

FIG. 5 shows an exploded, perspective view of a temple folding structure according to a third embodiment of the present invention.

### DETAILED DESCRIPTION OF THE INVENTION

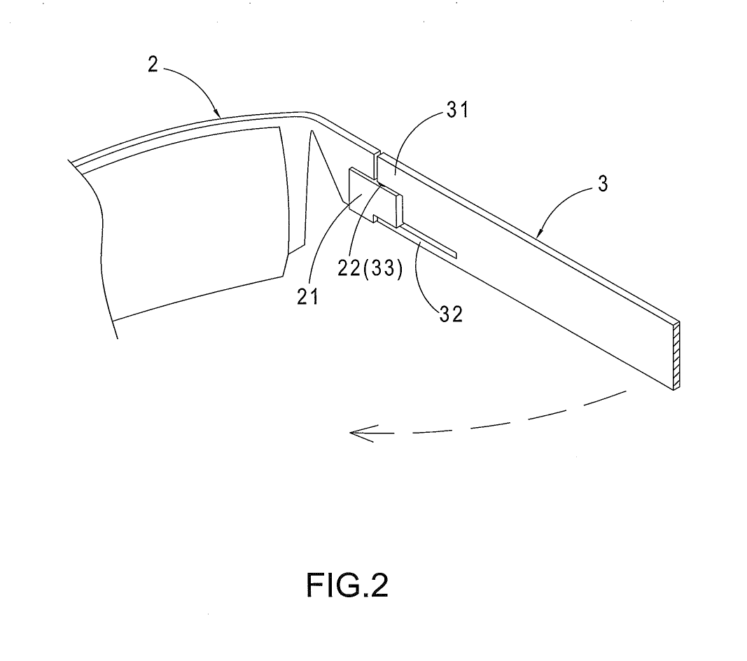

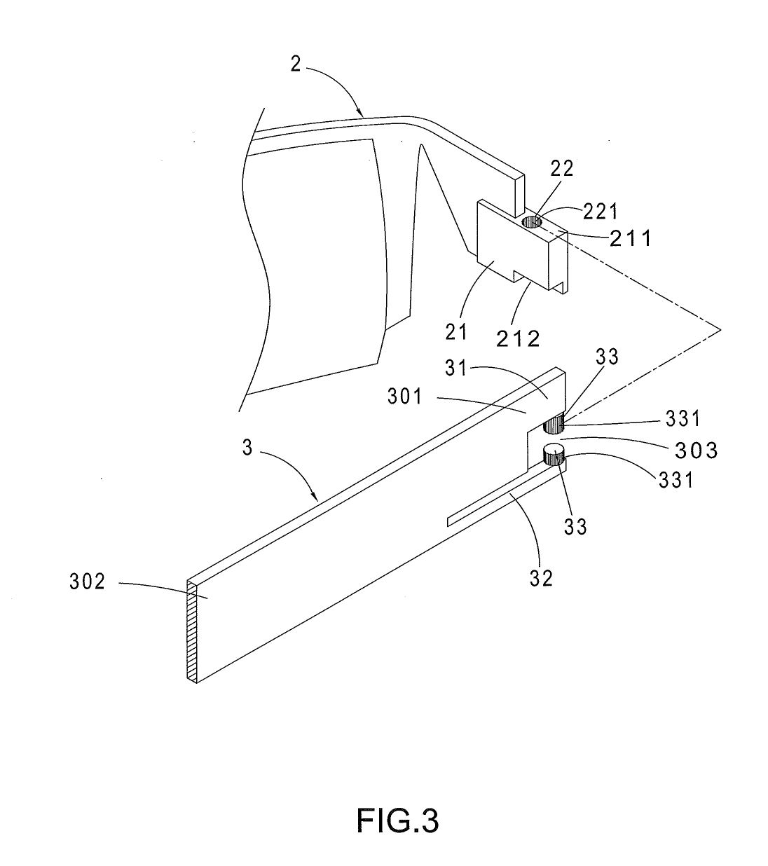

A temple folding structure on a pair of eyeglasses according to a first embodiment of the present invention is shown in FIGS. 2 and 3 of the drawings and includes a lens frame 2 and a temple 3. The lens frame 2 includes an engaging portion 21 formed at one of two lateral sides thereof. The engaging portion 21 includes upper and lower faces 211 and 212 spaced in an axial direction and a mounting hole 22 extending from the upper face 211 through the lower face 212 in the axial direction. A plurality of teeth 221 is formed on an inner surface of the mounting hole 22 and extends in the axial direction.

The temple 3 includes an inner end 301 and an outer end 302 spaced from the inner end 301 in a length direction thereof perpendicular to the axial direction and adapted to be worn on an ear of a user. The temple 3 further includes upper and lower connection segments 31 and 32 formed at the inner end 301 thereof. The upper and lower connection segments 31 and 32 are axially separated by a width of the engaging portion 21 and define an opening 303 therebetween in the inner end 301. A pivot 33 is provided on each of a bottom surface of the upper connection segment 31 and a top surface of the lower connection segment 32. Each pivot 33 is designed to have a plurality of anchoring teeth 331 distributed around the pivot 33 and extending in the axial direction. The upper and lower connection segments 31 and 32 of the temple 3 clamp the engaging portion 21, with the pivots 33 on the upper and lower connection segments 31 and 32 respectively inserted into upper and lower sections of the mounting hole 22 and with the anchoring teeth 331 meshing with teeth 221 in the mounting hole 22, thereby allowing the temple 3 to be pivoted inwards or outwards relative to the lens frame 2 about an axis defined by the pivots 33.

With the pivots 33 on the temple 3 inserted into the mounting hole 22 of the engaging portion 21 of the lens frame 2, the temple folding structure according to the present invention allows simple assembly of the temple 3 to the lens frame 2. Furthermore, in contrast to conventional temple folding structures which are totally folded outwards or inwards at two angles only, the temple folding structure according to the present invention allows outward or inward folding and positioning of the temple 3 at various angles based on engagement of anchoring teeth 331 and teeth 221. Additionally, the temple folding structure according to the present invention contributes to fine quality and value of a pair of eyeglasses (particularly a pair of high-price eyeglasses).

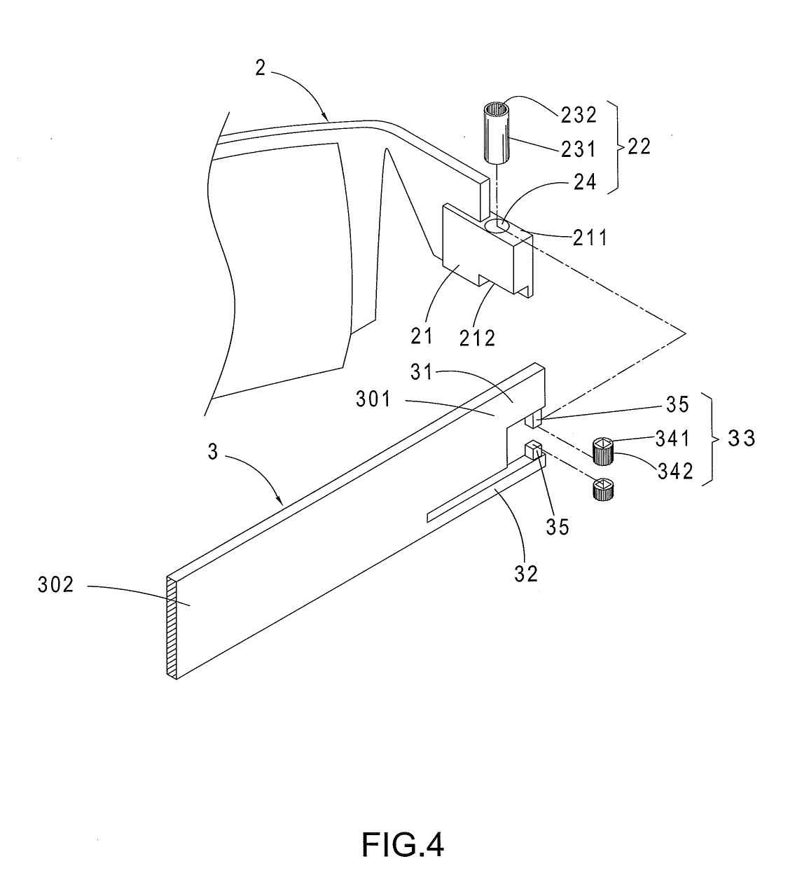

Now that the basic teachings of the present invention have been explained, many extensions and variations will be obvious to one having ordinary skill in the art. The temple folding structure shown in FIG. 4 is a modification of that shown in FIGS. 2 and 3, wherein the mounting hole 22 of the lens frame 2 is formed by a combination of a through-hole 24 and a coupling cylinder 231 compactly held in the through-hole 24. The through-hole 24 extends from the upper face 211 through the lower face 212 of the engaging portion 21, and the coupling cylinder 231 includes a plurality of teeth 232 formed on an inner surface of the coupling cylinder 231 and extending in the axial direction. Further, each pivot 33 is formed by a combination of a protruding portion 35 and a toothed ring 341 securely engaged around the protruding portion 35. The protruding portion 35 is provided on each of the bottom surface of the upper connection segment 31 and the top surface of the lower connection segment 32. The toothed ring 341 has a plurality of anchoring teeth 342 extending in the axial direction and matching the teeth 232. The temple folding structure according to this embodiment can provide workpieces easily machined.

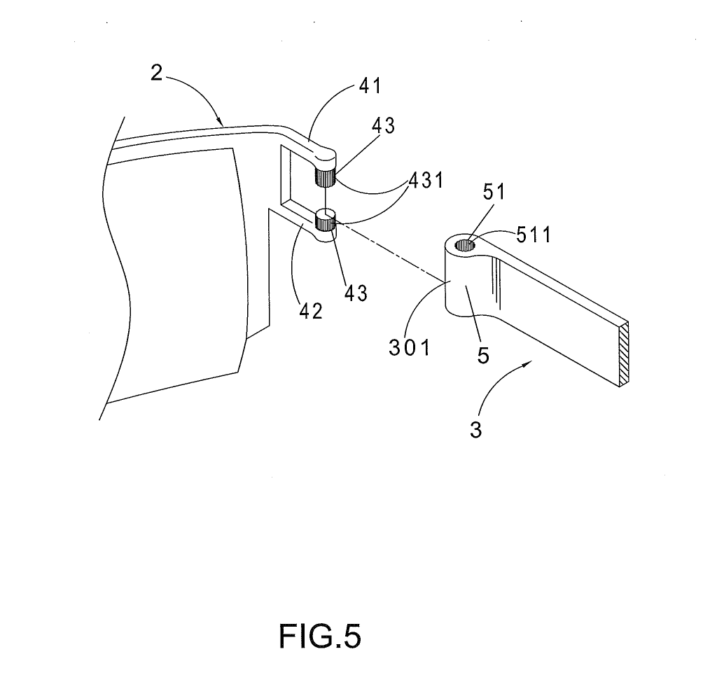

FIG. 5 illustrates a temple folding structure in an alternative embodiment of the present invention. In the embodiment, the lens frame 2 includes upper and lower connection segments 41 and 42 which are formed at one of the two lateral sides thereof and axially separated. A pivot 43 is provided on each of a bottom surface of the upper connection segment 41 and a top surface of the lower connection segment 42. Each pivot 43 is designed to have a plurality of anchoring teeth 431 distributed around the pivot 43 and extending in the axial direction. The temple 3 includes an engaging portion 5 formed at the inner end 301 thereof. The engaging portion 5 includes a mounting hole 51 extending through the engaging portion 5 in the axial direction. A plurality of concave-convex teeth 511 is formed on an inner surface of the mounting hole 51 and extends in the axial direction. The engaging portion 5 has a width in the axial direction approximately equal to a spacing of the upper and lower connection segments 41 and 42 in the axial direction. The upper and lower connection segments 41 and 42 of the lens frame 2 clamp the engaging portion 5 of the temple 3, with the pivots 43 on the upper and lower connection segments 41 and 42 respectively inserted into upper and lower sections of the mounting hole 51 and with the anchoring teeth 431 meshing with the teeth 511 in the mounting hole 51, thereby allowing the temple 3 to be pivoted inwards or outwards relative to the lens frame 2 about an axis defined by the pivots 43 and to be fixed at various angles. Accordingly, the mounting hole 22, 51 can be provided on the lens frame 2 or the temple 3, while the pivots 33, 43 can be provided on the temple 3 or the lens frame 2 according to demands.

The temple folding structure of the present invention has at least the following advantages in contrast to temple folding structures based on the prior art:

(1). The pivots 33, 43 can be directly pivoted in the mounting hole 22, 51, so that the temple folding structure of the present invention is assembled with neither screws nor other tools required and benefits not only assembly of a pair of eyeglasses but also no screw loosened after a long period of time.

(2). The temple 3 is capable of rotating relative to the lens frame 2 and can be stopped at various angles based on engagement strength of anchoring teeth 331, 431 and teeth 221, 511, so that the temple folding structure of the present invention can improve the quality of the pair of eyeglasses.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A temple folding structure on a pair of eyeglasses comprising:
a lens frame including an engaging portion formed at one lateral side of the lens frame, with the engaging portion including upper and lower faces spaced in an axial direction and a mounting hole extending from the upper face through the lower face in the axial direction, with a plurality of teeth formed on an inner surface of the mounting hole and extending in the axial direction; and
a temple including an inner end pivotably connected to the lateral side of the lens frame, with the temple further including upper and lower connection segments formed at the inner end of the temple and spaced in the axial direction, with a pivot provided on each of a bottom surface of the upper connection segment and a top surface of the lower connection segment and including a plurality of anchoring teeth distributed around the pivot and extending in the axial direction, with the upper and lower connection segments clamping the engaging portion, with the pivots on the upper and lower connection segments respectively inserted into upper and lower sections of the mounting hole to allow the temple to be pivoted relative to the lens frame about an axis defined by the pivots, with the anchoring teeth meshing with the teeth in the mounting hole.

2. The temple folding structure according to claim 1, wherein the mounting hole of the lens frame is formed by a combination of a through-hole and a coupling cylinder compactly held in the through-hole, with the through-hole extending through the engaging portion, with the coupling cylinder including the plurality of teeth formed on an inner surface of the coupling cylinder.

3. The temple folding structure according to claim 2, wherein the pivot is formed by a combination of a protruding portion and a toothed ring securely engaged around the protruding portion, with the protruding portion provided on each of the bottom surface of the upper connection segment and the top surface of the lower connection segment, with the toothed ring having the plurality of anchoring teeth extending in the axial direction.

4. A temple folding structure on a pair of eyeglasses comprising:
a lens frame including upper and lower connection segments which are formed at one lateral side of the lens frame and spaced in a axial direction, with a pivot provided on each of a bottom surface of the upper connection segment and a top surface of the lower connection segment, with each pivot including a plurality of anchoring teeth distributed around the pivot and extending in the axial direction; and
a temple including an inner end pivotably connected to the lateral side of the lens frame, with the temple further including an engaging portion formed at the inner end of the temple, with the engaging portion including a mounting hole extending therethrough in the axial direction, with a plurality of teeth formed on an inner surface of the mounting hole and extending in the axial direction, with the engaging portion having a width in the axial direction approximately equal to a spacing of the upper and lower connection segments in the axial direction, with the upper and lower connection segments of the lens frame clamping the engaging portion, with the pivots on the upper and lower connection segments respectively inserted into upper and lower sections of the mounting hole, and with the anchoring teeth meshing with teeth in the mounting hole, allowing the temple to be pivoted relative to the lens frame about an axis defined by the pivots.

5. The temple folding structure according to claim 4, wherein the mounting hole is formed by a combination of a through-hole and a coupling cylinder compactly held in the through-hole, with the through-hole extending through the engaging portion, with the coupling cylinder including the plurality of teeth formed on an inner surface of the coupling cylinder, wherein the pivot is formed by a combination of a protruding portion and a toothed ring securely engaged around the protruding portion, with the protruding portion provided on each of the bottom surface of the upper connection segment and the top surface of the lower connection segment, with the toothed ring having the plurality of anchoring teeth extending in the axial direction.
